(19) United States
(12) Patent Application Publication
(10) Pub. No.: US 2005/0219958 A1
(43) Pub. Date: Oct. 6, 2005

(54) Analog timepiece with second hand correcting mechanism

(76) Inventor: Tamotsu Ono, Chiba-shi (JP)

Correspondence Address: BRUCE L. ADAMS, ESQ., 31ST FLOOR, 50 BROADWAY, NEW YORK, NY, 10004, US

(21) Appl. No.: 11/088,061

(22) Filed: Mar. 23, 2005

(30) Foreign Application Priority Data
Mar. 30, 2004 (JP) 2004-097816

(51) Int. Cl. G04B 19/22; G04B 27/02

(52) U.S. Cl. 368/190

(57) ABSTRACT

To make it possible that a gear wheel whose rotation is corrected by a gear train setting lever at time of correcting the second hand always stops at its precise angle position at the moment it has been corrected. A second hand correcting mechanism which corrects the second hand through the fourth wheel contains a correcting disc disposed so as to rotate and stop together with the fourth wheel. If a winding stem is pulled out to its 1st stage, a setting lever and a yoke rotate to thereby rotate a correcting lever about a rotation pivot, and a correcting part of the correcting lever is pressed to a circumference face of the correcting disc. Thereupon, the correcting disc stops its rotation at that angle position, and a rotation of the fourth wheel is corrected.

### BACKGROUND OF THE INVENTION

1. Field of the Invention

The present invention relates to an analog timepiece possessing a second hand correcting mechanism which forcibly corrects the second hand when starting a time correction and releases the correction when the time has been corrected.

2. Description of the Prior Art

In a timepiece possessing the second hand in addition to an hour hand and a minute hand, a user requiring the accurate time not only of the hour and minute but down to the second, the time correcting is performed by the following procedures. First, when the second hand has become a position of 00 second, the hand motion of the second hand is forcibly stopped by pulling out a winding stem. Under this state by rotating the winding stem, the hour hand and the minute hand are set to the beginning of an hour, e.g., 11 o'clock 00 minute. And, the time correcting is finished by releasing the hand motion of the stopped second hand by pushing in the winding stem synchronously with a radio's announcement of time of 11 o'clock 00 minute 00 second.

As disclosed in FIG. 5 of JP-A-10-288678 Gazette (Patent Document 1), a conventional second hand correcting mechanism is a mechanism in which, by pressing a correcting part of a gear train setting lever to a tooth tip of a gear wheel to be corrected, its rotation is corrected. The gear train setting lever is disposed such that, when the second hand is moving as usual, the above correcting part is separated from the tooth tip of the gear wheel to be corrected. If the winding stem is pulled out to its 1st stage at time of correcting the second hand, the gear train setting lever rotates through a force transmission component such as setting lever, and the correcting part of the setting lever is pressed to the tooth tip of the gear wheel to be corrected, thereby correcting its rotation. Incidentally, the above-mentioned gear wheel to be corrected is the fourth wheel or the fifth wheel, which controls the motion of the second hand.

Further, a conventional second hand correcting mechanism disclosed in FIG. 18 of JP-A-2004-20422 Gazette (Patent Document 2) is a mechanism in which, by pressing the correcting part of the gear train setting lever to the tooth tip of a small secondhand intermediary wheel, its rotation is corrected. The gear train setting lever is disposed such that, when the second hand is moving as usual, the above correcting part is separated from the tooth tip of the small second hand intermediary wheel. If the winding stem is pulled out to its 1st stage at the second hand correcting time, the gear train setting lever is linearly moved via a force transmission component such as a setting lever, and its correcting part is pressed to the tooth tip of the gear wheel to be corrected, thereby correcting its rotation.

By the way, in a case where the second hand correcting has been performed by pressing the correcting part of the gear train setting lever to the tooth tip of the gear wheel to be corrected, if the above correcting part simultaneously contacts with tip portions of two teeth adjoining each other, the above gear wheel to be corrected stops at that position. However, a case where the above correcting part contacts with the tip part of only one tooth is more frequent than the case where the above correcting part simultaneously contacts with tip portions of two teeth adjoining each other. In a case of the former, there is a tendency that the above gear wheel to be corrected does not stop at that position, but the above gear wheel to be corrected rotates a little so that the above correcting part contacts with one of the two adjoining teeth. That is, there is a tendency that the above gear wheel to be corrected does not stay at a position contacting only one tooth, but rather rotates by a little until it reaches a position where the correcting part settles upon two teeth. Thereupon, there is a problem that the second hand which had pointed precisely at one mark of a dial deviates somewhat.

For example, let the gear wheel to be corrected be the fourth wheel of 40 teeth, the angle spacing between the teeth adjoining each other is 9 degrees (360 degrees/40), and the position where the correcting part of the gear train setting lever settles while contacting with the two teeth be one-half that angle, 4.5 degrees (9 degrees/2). In this case, the correcting part of the gear train setting lever rotates by an additional 4.5 degrees from the position where it has contacted with the tip portion of one tooth of the fourth wheel of 40 teeth,and the above fourth wheel stops. Since the angle between marks for seconds on the dial is 6 degrees, it follows that there arises a disadvantage that the second hand deviates by 0.75 graduation (4.5/6) from the correct position. For example, in a case where the hand motion of the second hand was forcibly stopped by pulling out the winding stem when the second hand had become 00 second, it follows that the second hand stops at a position where it deviates by 0.75 graduation from the position of 00 second.

<Patent Document 1>
JP-A-10-288678

<Patent Document 2>
JP-A-2004-20422

A problem that the present invention is to solve is to make it possible that, in an analog timepiece possessing a second hand correcting mechanism, a gear wheel whose rotation is corrected by a gear train setting lever at time of correcting the second hand always stops at its angle position at the moment it has been corrected.

### SUMMARY OF THE INVENTION

In order to solve the above problem, a mechanism is constructed so that by pressing a correcting part of a gear train setting lever to a circumference face of a correcting disc disposed so as to rotate and stop together with a gear wheel to be corrected, the above gear wheel is corrected.

### BRIEF DESCRIPTION OF THE SEVERAL VIEWS OF THE DRAWINGS

A preferred form of the present invention is illustrated in the accompanying drawings in which:

FIG. 1 is a plan view of a main part of an analog timepiece, of an Embodiment 1 of the present invention, possessing a second hand correcting mechanism which corrects a fourth wheel;

FIG. 2 is a sectional view of the main part of the analog timepiece, of the Embodiment 1 of the present invention, possessing the second hand correcting mechanism which corrects the fourth wheel;

FIG. 3 is a plan view of a main part of an analog timepiece, of an Embodiment 2 of the present invention, possessing a second hand correcting mechanism which corrects a fifth wheel;

FIG. 4 is a sectional view of the main part of the analog timepiece, of the Embodiment 2 of the present invention, possessing the second hand correcting mechanism which corrects the fifth wheel;

FIG. 5 is a plan view of a main part of an analog timepiece, of an Embodiment 3 of the present invention, possessing a second hand correcting mechanism which corrects a second wheel;

FIG. 6 is a sectional view of the main part of the analog timepiece, of the Embodiment 3 of the present invention, possessing the second hand correcting mechanism which corrects the second wheel;

FIG. 7 is a plan view of a main part of an analog timepiece, of an Embodiment 4 of the present invention, possessing a second hand correcting mechanism which corrects an second hand intermediary wheel; and

FIG. 8 is a sectional view of the main part of the analog timepiece, of the Embodiment 4 of the present invention, possessing the second hand correcting mechanism which corrects the second hand intermediary wheel.

### DETAILED DESCRIPTION OF THE PREFERRED EMBODIMENTS

The present invention is one characterized by possessing, in an analog timepiece displaying the time down to the second by driving a gear train with a motor, a second hand correcting mechanism of the following construction. That is, the above second hand correcting mechanism is one constituted by containing a correcting disc disposed so as to rotate and stop together with a gear wheel whose rotation is corrected at time of correcting the second hand, a gear train setting lever having a correcting part, and a gear train setting lever drive mechanism which drives the gear train setting lever such that, when the second hand is moving as usual, the correcting part is retained in a position separated from a circumference face of the correcting disc and, at the second hand correcting time, it is pressed to the circumference face of the correcting disc.

### Embodiment 1

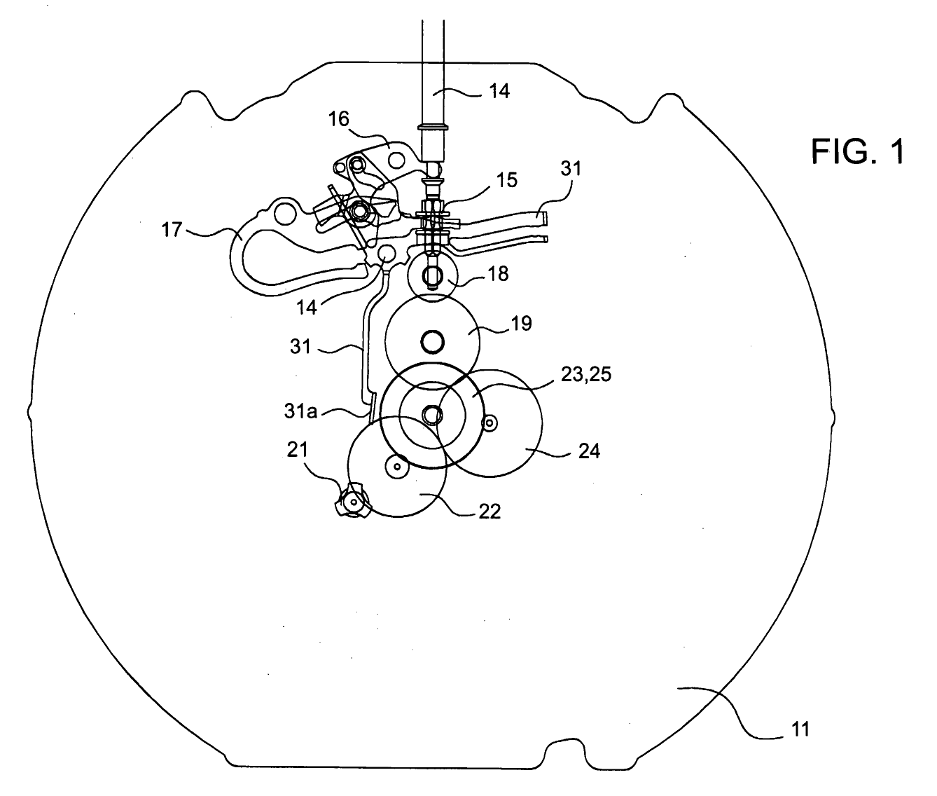

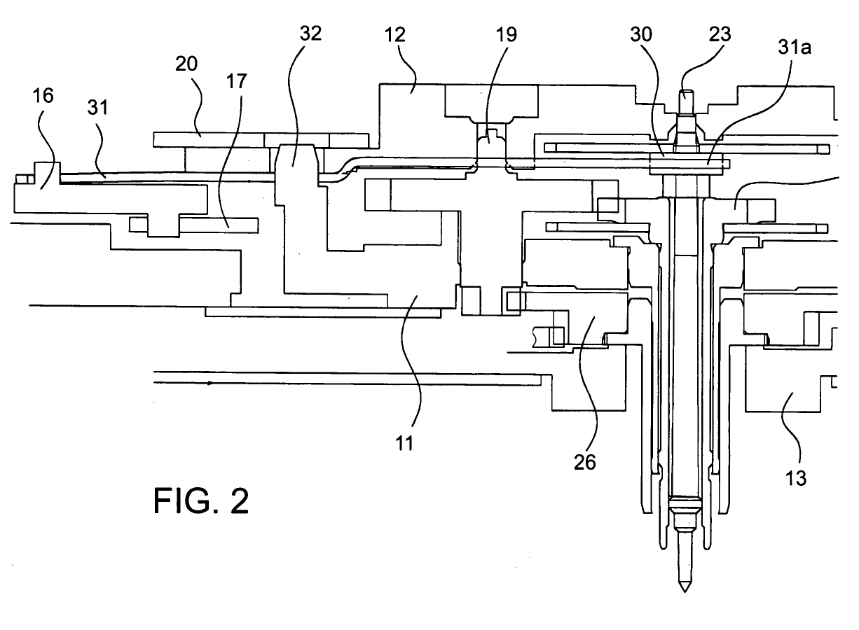

As shown in a plan view of FIG. 1 and a sectional view of FIG. 2, an analog timepiece of the Embodiment 1 is a center 3-hand type analog timepiece in which rotating axles of an hour hand, a minute hand and a second hand have been coaxially disposed in a center position of a main plate 11, i.e., analog timepiece displaying a time till a time unit by rotating the hour hand, the minute hand and the second hand by driving a gear train by a rotation of a rotor of a step motor one, possessing a second hand correcting mechanism which corrects the second hand through the fourth wheel.

The above gear train contains a fifth wheel 22, a fourth wheel 23, a third wheel 24 and a second wheel 25, which have been rotatably attached to a gear train bridge 12 and a 2nd gear train bridge 13. The rotor 21 is for instance the rotor of a step motor which rotates by 180 degrees every second. It is constituted such that the fifth wheel 22 rotates along with the rotation of the rotor 21, and the fourth wheel 23 rotates along with the rotation of the fifth wheel 22. Further, it is constituted such that the third wheel 24 rotates along with rotation of the fourth wheel, and the second wheel 25 rotates along with rotation of the third wheel 24. The rotation center of the hour hand, the minute hand and the second hand is the same as a rotation center of the fourth wheel 23. The second hand is attached to the rotating axle of the fourth wheel, and the minute hand is attached to a cannon pinion of the second wheel. The hour hand is attached to a center pipe, and rotated via a tube wheel 26 and the second wheel 25.

The second hand correcting mechanism which corrects the second hand through the fourth wheel is constituted by a correcting disc 30 disposed so as to rotate and stop together with the fourth wheel 23, a gear train setting lever 31 correcting the correcting disc 30, a gear train setting lever drive mechanism which rotates the gear train setting lever 31. The correcting disc 30 is a disk having a diameter of about ¼ that of the fourth wheel 23 and having a thickness of about 3 times that of the fourth wheel 23. The correcting disc 30 is coaxially secured to a rotating axle of the fourth wheel 23 with its upper face being contacted with a lower face of the fourth wheel 23.

The gear train setting lever 31 is a component having at its tip a correcting part 31a. When the second hand is moving as usual, the correcting part 31a of the gear train setting lever 31 is separated from the circumference surface of the correcting disc 30. If a winding stem 14 is pulled out to its 1st stage, a setting lever 16 and a yoke 17 rotate, thereby rotating the gear train setting lever 31 about a rotation pivot 32. Thereupon, the correcting part 31a of the gear train setting lever 31 is pressed to the circumference face of the correcting disc 30, the correcting disc 30 stops its rotation at that angle position, and accordingly the rotation of the fourth wheel 23 is corrected.

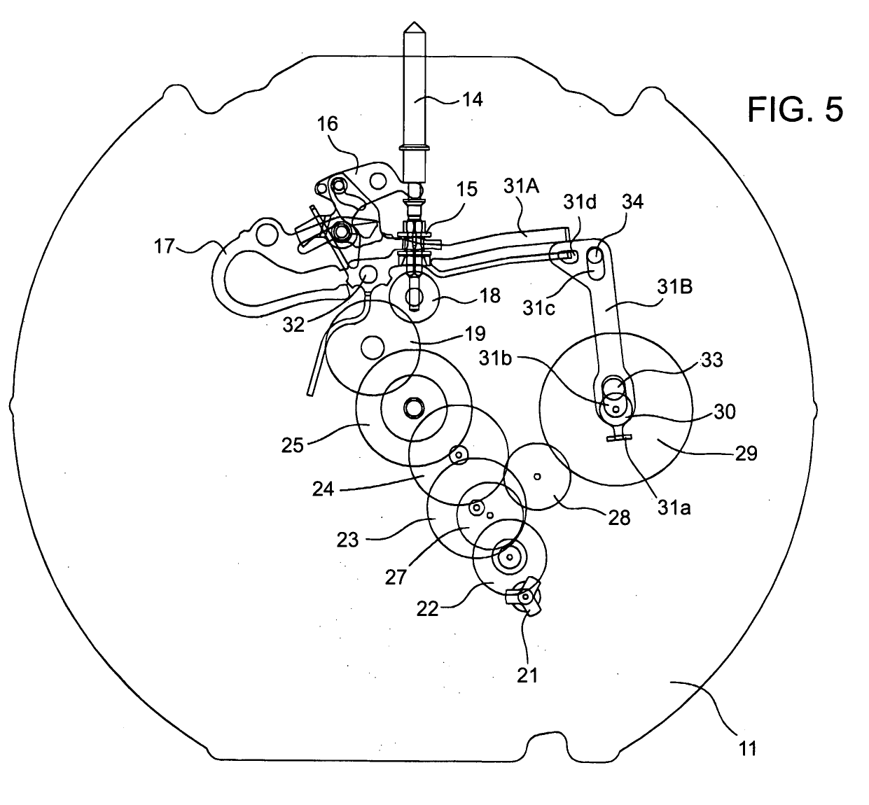

In the Embodiment 1, the gear train setting lever drive mechanism which drives the gear train setting lever 31 so as to rotate the correcting part 31a is constituted by the winding stem 14 and force transmission components like the setting lever 16 and the yoke 17. For this gear train setting lever drive mechanism, it is possible to utilize a gear train setting lever drive mechanism used in the conventional second hand correcting mechanism which, at the correcting time, corrects the second hand by rotating the gear train setting lever so that its correcting part presses against a tooth tip of the fourth wheel, for example, the one as disclosed in FIG. 5 of the Patent Document 1. Incidentally, in the present Embodiment and also in the Embodiment mentioned below, although they describe the case where in an electronic analog timepiece electrical energy is made a drive source, it is possible to adopt these Embodiments also in a mechanical timepiece in which mechanical energy is made a power source.

### Embodiment 2

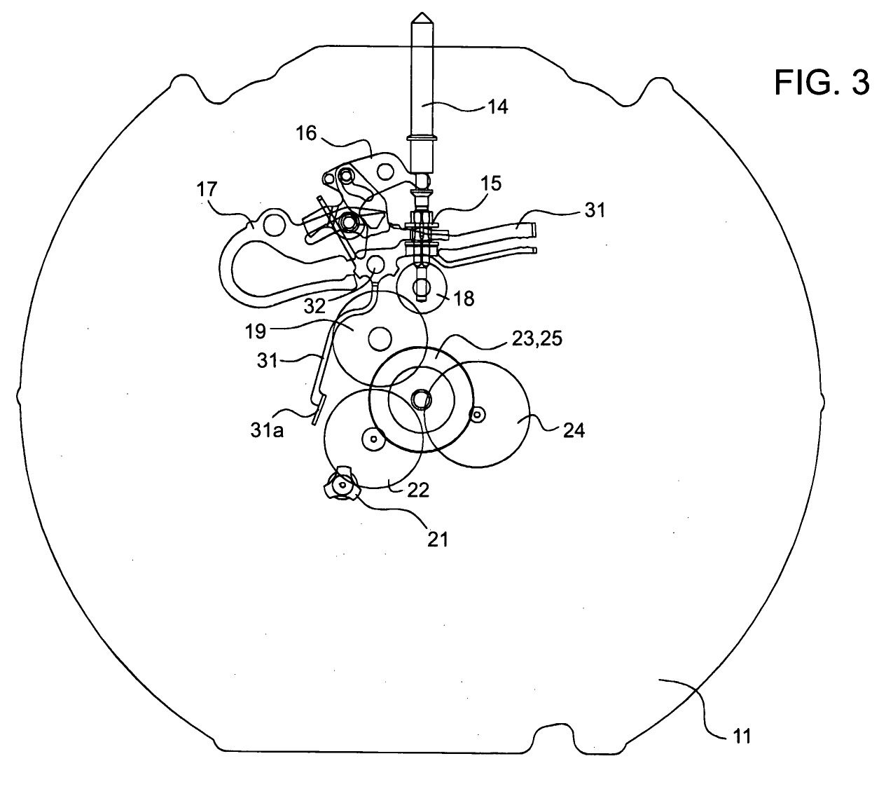

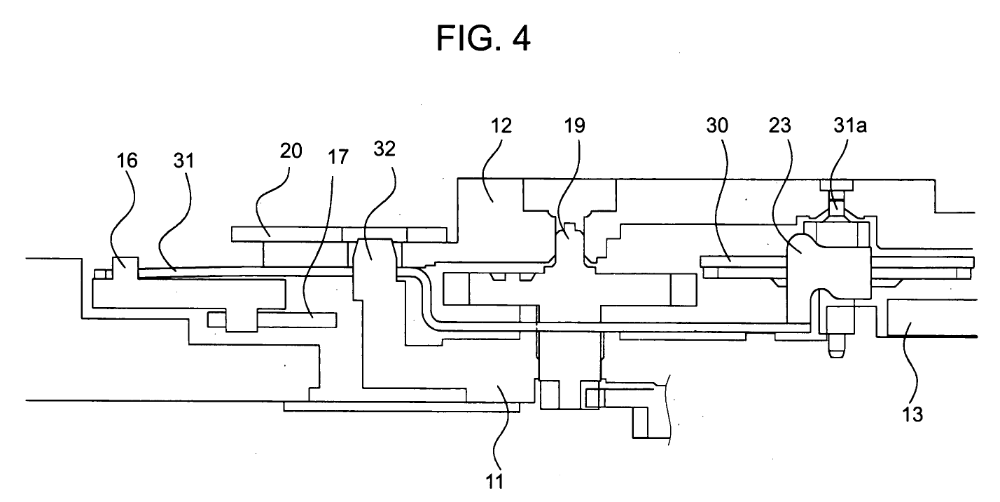

As shown in a plan view of FIG. 3 and a sectional view of FIG. 4, an analog timepiece of the Embodiment 2 is a center 3-hand type analog timepiece in which the rotating axles of the hour hand, the minute hand and the second hand have been coaxially disposed in the center position of the main plate 11, i.e., analog timepiece displaying the time down to the second by rotating the hour hand, the minute hand and the second hand by driving the gear train by the rotation of the rotor of the step motor, possessing a second hand correcting mechanism which corrects the second hand through the fifth wheel.

The above gear train contains the fifth wheel 22, the fourth wheel 23, the third wheel 24, and the center wheel 25, which have been rotatably attached to the gear train bridge 12 and the 2nd gear train bridge 13. The rotor 21 is the rotor of the step motor which rotates, e.g., by 180 degrees every second. It is constituted such that the fifth wheel 22 rotates along with the rotation of the rotor 21, and the fourth wheel 23 rotates along with the rotation of the fifth wheel 22. Further, it is constituted such that the third wheel 24 rotates along with the rotation of the fourth wheel 23, and the center wheel 25 rotates along with the rotation of the third wheel 24. The rotation centers of the hour hand, the minute hand and the second hand are the same as the rotation center of the center wheel 23. The second hand is attached to the rotating axle of the fourth wheel, and the minute hand is attached to the cannon pinion of the center wheel. The hour hand is attached to the center pipe, and rotated through the hour wheel 26 and the center wheel 25.

The second hand correcting mechanism which corrects the second hand through the fifth wheel is constituted by the correcting disc 30 disposed so as to rotate and stop together with the fifth wheel 22, the gear train setting lever 31 correcting the correcting disc 30, and the gear train setting lever drive mechanism which rotates the gear train setting lever 31. The correcting disc 30 is a disk having a diameter somewhat larger than the fifth wheel 22 and having a thickness of a degree similar to the same. The correcting disc 30 is coaxially secured to the rotating axle of the fifth wheel 23 with its lower face contacting the upper face of the fifth wheel 22.

The gear train setting lever 31 is the component having in its tip the correcting part 31a. When the second hand is moving as usual, the correcting part 31a of the gear train setting lever 31 is separated from the circumference face of the correcting disc 30. If the winding stem 14 is pulled out to its 1st stage, the setting lever 16 and the yoke 17 rotate, thereby rotating the gear train setting lever 31 about the rotation pivot 32. Thereupon, the correcting part 31a of the gear train setting lever 31 is pressed to the circumference face of the correcting disc 30, the correcting disc 30 stops its rotation in that angle position, and accordingly the rotation of the fifth wheel 22 is corrected.

In the Embodiment 2, the gear train setting lever drive mechanism which drives the gear train setting lever 31 so as to rotate the correcting part 31a is constituted by the winding stem 14 and the force transmission components like the setting lever 16 and the yoke 17. For this gear train setting lever drive mechanism, it is possible to utilize the gear train setting lever drive mechanism used in the conventional second hand correcting mechanism which, at the correcting time, corrects the second hand by rotating the gear train setting lever so that its correcting part presses against the tooth tip of the fifth wheel, for example, the one disclosed in FIG. 5 of the Patent Document 1.

### Embodiment 3

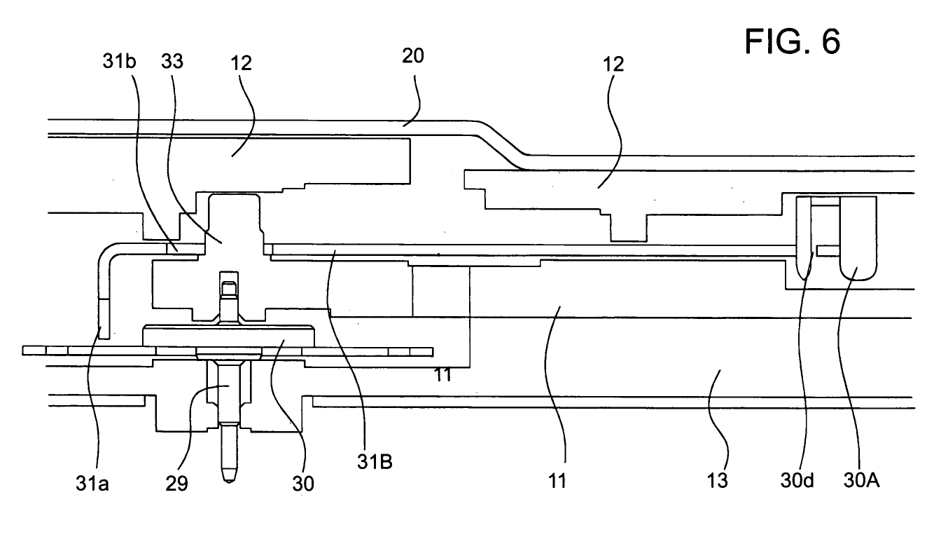

As shown in a plan view of FIG. 5 and a sectional view of FIG. 6, an analog timepiece of the Embodiment 3 is one possessing the second hand correcting mechanism which corrects the second hand through the second wheel in a small second hand type analog timepiece in which the rotating axles of the hour hand and the minute hand have been coaxially disposed in the center position of the main plate 11 and the rotating axle of the second hand has been disposed separately, in the 3 o'clock direction from the center position of the main plate 11, this analog timepiece displaying the time to the second by rotating the hour hand, the minute hand and the second hand by driving the gear train by the rotation of the rotor of the step motor.

The above gear train contains the fifth wheel 22, the fourth wheel 23, the third wheel 24, the center wheel 25, a 1st second hand intermediary wheel 27 and a 2nd second hand intermediary wheel 28, which have been rotatably attached to the gear train bridge 12 and the 2nd gear train bridge 13. The rotor 21 is the rotor of the step motor which rotates, e.g., by 180 degrees in every one second. It is constituted such that the fifth wheel 22 rotates along with the rotation of the rotor 21, and the fourth wheel 23 and the 1st second hand intermediary wheel 27 rotate along with the rotation of the fifth wheel 22. Further, it is constituted such that the third wheel 24 rotates along with the rotation of the fourth wheel 23, and the center wheel 25 rotates along with the rotation of the third wheel 24. Additionally, it is constituted such that the 2nd second hand intermediary wheel 28 rotates along with a rotation of the 1st second hand intermediary wheel 27, and a second hand wheel 29 rotates along with a rotation of the 2nd second hand intermediary wheel 28. The rotation center of each of the hour hand and the minute hand is the same as the rotation center of the fifth wheel 22. The second hand is attached to a rotating axle of the second hand wheel 29 disposed in a separate position in the 3 o'clock direction from the rotation center of the fifth wheel 22. The minute hand is attached to the cannon pinion of the center wheel. The hour hand is attached to the center pipe, and rotated through the hour wheel 26 and the center wheel 25.

The second hand correcting mechanism which corrects the second hand through the second wheel is constituted by the correcting disc 30 disposed so as to rotate and stop together with the second hand wheel 29, the gear train setting lever 31 correcting the correcting disc 30, and the gear train setting lever drive mechanism which linearly drives the gear train setting lever 31. The correcting disc 30 is a disk having a diameter of about ¼ of the second hand wheel 29 and having a thickness about 3 times greater. The correcting disc 30 is coaxially secured to the rotating axle of the second hand wheel 29 with its lower face contacting the upper face of the second hand wheel 29.

The gear train setting lever 31 is constituted by 2 components, a gear train setting lever 31A and a gear train setting lever 31B. The gear train setting lever 31A is the component rotating about a rotation pivot 32, and the gear train setting lever 31B is the component having in its tip the correcting part 31a. There is formed in the end part of correcting lever 31B toward correcting part 31A a guide window 31b, and in the other end of correcting lever 31B there are formed a guide window 31c and an operation window 31d. An operation pin attached to the end part of the gear train setting lever 31A engages with the operation window 31d. Further, the guide window 31b and the guide window 31c engage with guide pins 33, 34 formed in the main plate 11.

When the second hand is moving as usual, the correcting part 31a of the gear train setting lever 31 is separated from the circumference face of the correcting disc 30. If the winding stem 14 is pulled out to its 1st stage, the setting lever 16 and the yoke 17 rotate, the gear train setting lever 31A is rotated about the rotation pivot 32, and the gear train setting lever 31A linearly moves the gear train setting lever 31B. Thereupon, the correcting part 31a of the gear train setting lever 31B is pressed to the circumference face of the correcting disc 30, the correcting disc 30 stops its rotation in that angle position, and accordingly the rotation of the second hand wheel 29 is corrected.

In the Embodiment 3, the gear train setting lever drive mechanism which drives the gear train setting lever 31 so as to linearly move the correcting part 31a is constituted by the winding stem 14 and the force transmission components like the setting lever 16 and the yoke 17. For this gear train setting lever drive mechanism, it is possible to utilize the gear train setting lever drive mechanism used in the conventional second hand correcting mechanism which, at the correcting time, corrects the second hand by linearly moving the gear train setting lever so that its correcting part presses against the tooth tip of the second wheel, for example, the one disclosed in FIG. 22 of the Patent Document 2.

### Embodiment 4

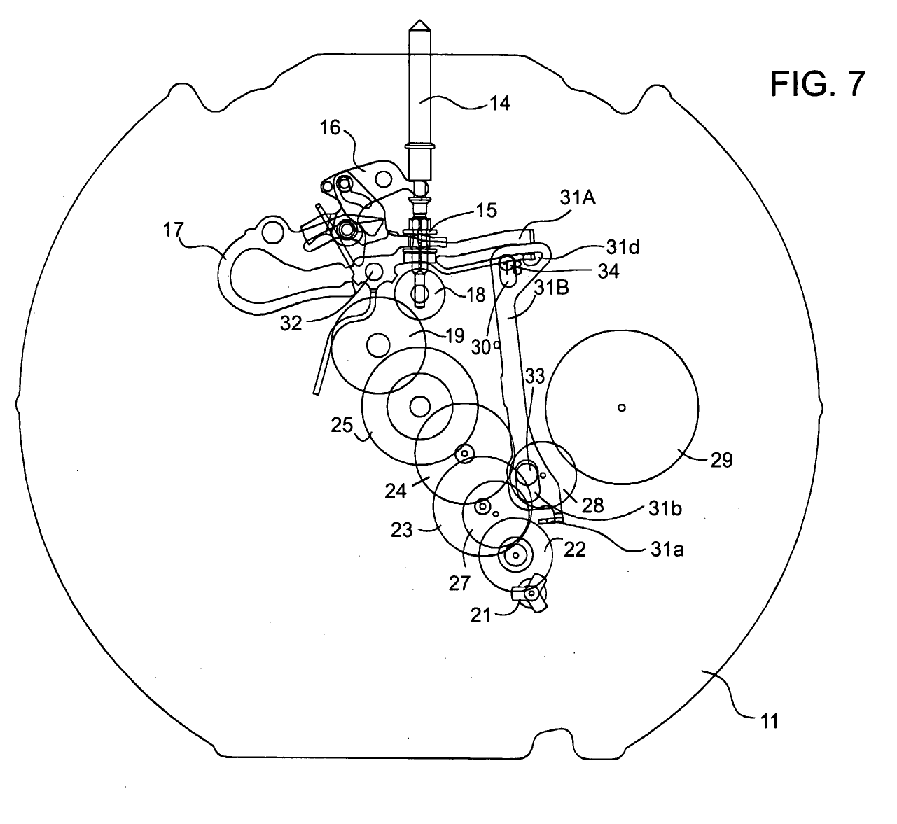

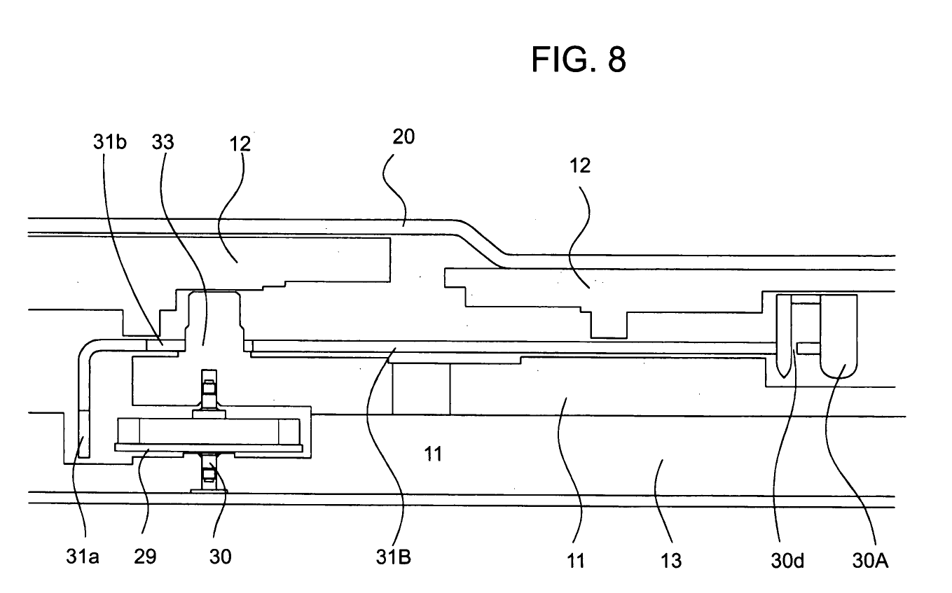

As shown in a plan view of FIG. 7 and a sectional view of FIG. 8, an analog timepiece of the Embodiment 4 is a small second hand type analog timepiece in which the rotating axles of the hour hand and the minute hand have been coaxially disposed in the center position of the main plate 11 and the rotating axle of the second hand has been separated, in the 3 o'clock direction from the center position of the main plate 11, an analog timepiece displaying the time to the second by rotating the hour hand, the minute hand and the second hand by driving the gear train by the rotation of the rotor of the step motor, possessing a second hand correcting mechanism which corrects the second hand through an second hand intermediary wheel.

The above gear train contains the fifth wheel 22, the fourth wheel 23, the third wheel 24, the center wheel 25, the 1st second hand intermediary wheel 27 and the 2nd second hand intermediary wheel 28, which have been rotatably attached to the gear train bridge 12 and the 2nd gear train bridge 13. The rotor 21 is the rotor of a step motor which rotates, e.g., by 180 degrees every second. It is constituted such that the fifth wheel 22 rotates along with the rotation of the rotor 21, and the fourth wheel 23 and the 1st second hand intermediary wheel 27 rotate along with the rotation of the fifth wheel 22. Further, it is constituted such that the third wheel 24 rotates along with the rotation of the fourth wheel 23, and the center wheel 25 rotates along with the rotation of the third wheel 24. Additionally, it is constituted such that the 2nd second hand intermediary wheel 28 rotates along with the rotation of the 1st second hand intermediary wheel 27, and the second hand wheel 29 rotates along with the rotation of the 2nd second hand intermediary wheel 28. The rotation center of the hour hand and the minute hand is the same as the rotation center of the fifth wheel 22. The second hand is attached to the rotating axle of the second hand wheel 29 which is separated in the 3 o'clock direction from the rotation center of the fifth wheel 22. The minute hand is attached to the cannon pinion of the center wheel. The hour hand is attached to the center pipe, and rotated through the hour wheel 26 and the center wheel 25.

The second hand correcting mechanism which corrects the second hand through the second hand intermediary wheel is constituted by the correcting disc 30 disposed so as to rotate and stop together with the 2nd second hand intermediary wheel 28, the gear train setting lever 31 correcting the correcting disc 30, and the gear train setting lever drive mechanism which linearly drives the gear train setting lever 31. The correcting disc 30 is a disc whose diameter is larger than the 2nd second hand intermediary wheel 28 and whose thickness is about ¼ of the same. The correcting disc 30 is coaxially secured to the rotating axle of the 2nd second hand intermediary wheel 28 with its upper face contacting the lower face of the 2nd second hand intermediary wheel 28.

The gear train setting lever 31 is constituted by the 2 components of the gear train setting lever 31A and the gear train setting lever 31B. The gear train setting lever 31A is the component rotating about the rotation pivot 32, and the gear train setting lever 31B is the component having at its tip the correcting part 31a. In the gear train setting lever 31B, there is formed at the end part toward the correcting part 31a the guide window 31b, and in the other end part there are formed the guide window 31c and the operation window 31d. The operation pin attached to the end part of the gear train setting lever 31A engages with the operation window 31d. Further, the guide window 31b and the guide window 31c engage with the guide pins 33, 34 formed in the main plate 11.

When the second hand is moving as usual, the correcting part 31a of the gear train setting lever 31B is separated from the circumference face of the correcting disc 30. If the winding stem 14 is pulled out to its 1st stage, the setting lever 16 and the yoke 17 rotate, the gear train setting lever 31A is rotated about the rotation pivot 32, and the gear train setting lever 31A linearly moves the gear train setting lever 31B. Thereupon, the correcting part 31a of the gear train setting lever 31B is pressed to the circumference face of the correcting disc 30, the correcting disc 30 stops its rotation at that angle position, and accordingly the rotation of the second hand wheel 29 is corrected.

In the Embodiment 4, the gear train setting lever drive mechanism which drives the gear train setting lever 31 so as to linearly move the correcting part 31a is constituted by the winding stem 14 and the force transmission components like the setting lever 16 and the yoke 17. For this gear train setting lever drive mechanism, it is possible to utilize the gear train setting lever drive mechanism used in the conventional second hand correcting mechanism which, at the correcting time, corrects it by linearly moving the gear train setting lever so that its correcting part presses against the tooth tip of the second hand intermediary wheel, for example, the one disclosed in FIG. 24 of the Patent Document 2.

In the present invention, the gear wheel whose rotation is corrected by the gear train setting lever at the second hand correcting time always stops at its angle position at the moment it has been corrected. Accordingly, in the analog timepiece possessing the second hand correcting mechanism concerning the present invention, the second hand deviation at the second hand correcting time is eliminated.

1. An analog timepiece which displays the time to the second by rotating an hour hand, a minute hand and a second hand by driving a gear train with a motor, comprising:
a correcting disc to be disposed so as to rotate or stop together with a gear wheel whose rotation is corrected when the second hand is corrected, and
wherein the correcting disc is corrected by a setting lever.

2. An analog timepiece with a second hand correcting mechanism, which displays a time to the second by rotating an hour hand, a minute hand and a second hand by driving a gear train with a motor, comprising:
a second hand correcting mechanism constituted by containing a correcting disc disposed so as to rotate and stop together with a gear wheel whose rotation is corrected when the second hand is corrected, a gear train setting lever having a correcting part, and a gear train setting lever drive mechanism which drives the gear train setting lever such that, when the secondhand is moving as usual, the correcting part is retained in a position separated from the circumference face of the correcting disc and, at the second hand correcting time, the correcting part is pressed to the circumference face of the correcting disc.

3. An analog timepiece with a second hand correcting mechanism according to claim 2,
Wherein the gear wheel is a fourth wheel.

4. An analog timepiece with a second hand correcting mechanism according to claim 2,
Wherein the gear wheel is a fifth wheel.

5. An analog timepiece with a second hand correcting mechanism according to claim 2,
Wherein the gear wheel is a second wheel.

6. An analog timepiece with a second hand correcting mechanism according to claim 2,
Wherein the gear wheel is a secondhand intermediary wheel.

7. An analog timepiece with a second hand correcting mechanism according to claim 2,
wherein the gear train setting lever drive mechanism is one containing a winding stem, and a motion conversion component converting a linear motion of the winding stem into a rotational motion.
